(19) United States
(12) Patent Application Publication
(10) Pub. No.: US 2007/0177405 A1
(43) Pub. Date: Aug. 2, 2007

(54) Backlight unit, liquid crystal display module and electronic device

(75) Inventors: Ming-Szu Chan, Hsinchu City (TW); Chih-Wei Chang Chien, Daliao Township (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/342,070

(22) Filed: Jan. 27, 2006

(51) Int. Cl. F21V 7/04; F21V 8/00

(52) U.S. Cl. 362/613; 362/612; 362/235

(57) ABSTRACT

The present invention provides a backlight unit. The backlight unit includes a light guide plate (LGP) having a incident surface and a plurality of light emitting diodes (LEDs) disposed adjacent to the incident surface. Each LED has an light-emitting axis, and the light-emitting axes are not parallel. The present invention further provides a liquid crystal display module including the backlight unit described above and a liquid crystal display panel disposed over the backlight unit. Moreover, the present invention provides an electronic device including the liquid crystal display module described above and a control circuitry electrically connected to the liquid crystal display module.

### BACKGROUND OF THE INVENTION

1. Field of the Invention

The invention relates in general to liquid crystal display modules (LCMs), and more particularly to the backlight unit of liquid crystal display modules.

2. Description of the Related Art

For transmissive and transflective liquid crystal displays (LCDs), the backlight unit provides a planarlight source to illuminate the liquid crystal panel for displaying images. More specifically, the light source of the backlight unit may be a cold cathode fluorescent lamp (CCFL) or an light-emitting diode array (LED array).

FIG. 1A and FIG. 1B are schematic plan views of conventional backlight units. Referring to FIG. 1A and FIG. 1B, conventional backlight unit 100 includes a light guide plate (LGP) 110 having an incident surface 110a and a plurality of light emitting diodes (LEDs) 120 disposed adjacent to the incident surface 110a. Each LED 120 has an light-emitting axis 122 perpendicular to the emitting surface of the LED 120, and a diverging light output having a divergence angle. In the conventional backlight unit 100, all of the light-emitting axes 122 of the LED 120 are parallel to each other. Specifically, all of the light-emitting axes 122 of the LED 120 are perpendicular to the incident surface 110a of the LGP 110.

As shown in FIG. 1A and FIG. 1B, in order to reduce costs of production, it is desired to use the least number of LEDs for a particular size of the LGP. For example, two or three LEDs 120 having a divergence angle about 120 degree may be used with an incident surface of about 30 to 40 mm long in the conventional backlight unit 100. As the number of the LEDs 120 used in the backlight unit 100 decreases, a visible phenomenon of “Fire-fly” will occur. In other words, some areas D appear darker in comparison with other areas of the LGP because the light-emitting coverage of the LEDs 120 are not enough to cover all area of the LGP 110. Specifically, the areas D located along the edge of the LGP between two adjacent LEDs 120 appear darker than other portions of the LGP 110. Therefore, the uniformity of the backlight unit is needed to be further enhanced.

### SUMMARY OF THE INVENTION

The present invention is directed to an edge-lit backlight unit that is lit by an array of discrete light sources with respect to an overall edge of the LGP, with reduced dark areas near such edge of the LGP. In one aspect of the present invention, the light sources have a diverging light output, and the light source is positioned with respect to the edge such that the divergence angle covers the edge portion of the LGP. The light source is positioned with respect to the edge such that the edge of the diverging light output is at least parallel to the incident surface or intercepting the incident surface. According to the present invention, a space is defined by a corner incident surface at least one end of the edge of the LGP, in which at least one light source having a diverging light output at a divergence angle is incident at the corner incident surface, wherein the light source is positioned with respect to the corner incident surface such that the light source substantially resides within the space and the diverging light output covers the edge portion of the LGP. The inventive structure improves the relative uniformity of the light intensity distribution across the LGP at a distance from the edge of the LGP.

In one embodiment, the incident surface edge of the LGP is provided with angled surfaces, thereby allowing the divergence of the light sources to cover closer along the edge of the LGP. In one embodiment, the angled surfaces are provided at the corner of the LGP or at the two ends of incident surface edge of the LGP.

As embodied and broadly described herein, the present invention provides a backlight unit. The backlight unit includes an LGP having an incident surface and a plurality of light emitting diodes (LEDs) disposed adjacent to the incident surface. Each LED has an light-emitting axis, and the light-emitting axes are not parallel.

As embodied and broadly described herein, the present invention provides a liquid crystal display module. The liquid crystal display module includes the backlight unit described above and a liquid crystal display panel disposed over the backlight unit.

As embodied and broadly described herein, the present invention provides an electronic device. The electronic device includes the liquid crystal display module described above and a control circuitry electrically connected to the liquid crystal display module.

In one embodiment of the present invention, the incident surface of the LGP comprising a pair of corner incident surface disposed in two corners of the LGP and a central incident surface located between the corner incident surfaces.

In one embodiment of the present invention, the LEDs may be disposed merely adjacent to the corner incident surfaces. In another embodiment of the present invention, the LEDs may be disposed adjacent to both the corner incident surfaces and the central incident surface.

In one embodiment of the present invention, the corner incident surface and the central incident surface may have an acute included angle about α₁ degree, and 0<α₁ <30. The light-emitting axis of the LED disposed adjacent to the corner incident surface is perpendicular to the corner incident surface correspondingly.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1A and FIG. 1B are schematic plan views of conventional backlight units.

FIG. 2A and FIG. 2B are schematic plan views of the backlight units in accordance with an embodiment of the present invention.

FIG. 2C is a schematic plan view showing the detail parameters (included angle and length etc.) of the backlight units in FIG. 2B.

FIG. 3A and FIG. 3B are schematic plan views of the backlight units in accordance with another embodiment of the present invention.

FIG. 4 is schematic cross-sectional view of the liquid crystal display module in accordance with one embodiment of the present invention.

FIG. 5 is schematic cross-sectional view of the electronic device in accordance with one embodiment of the present invention.

FIGS. 6A and 6B are graphical representation of the relative light intensity distribution across the LGP for a prior art structure.

FIGS. 7A and 7B are graphical representation of the relative light intensity distribution across the LGP for an inventive structure.

### DESCRIPTION OF THE PREFERRED EMBODIMENT

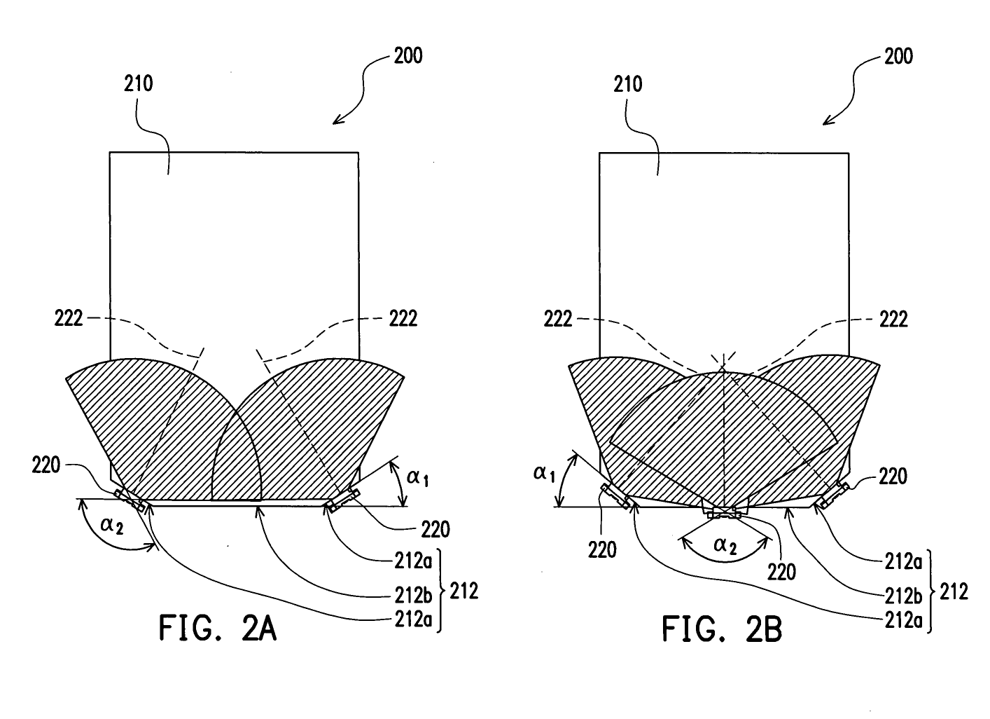

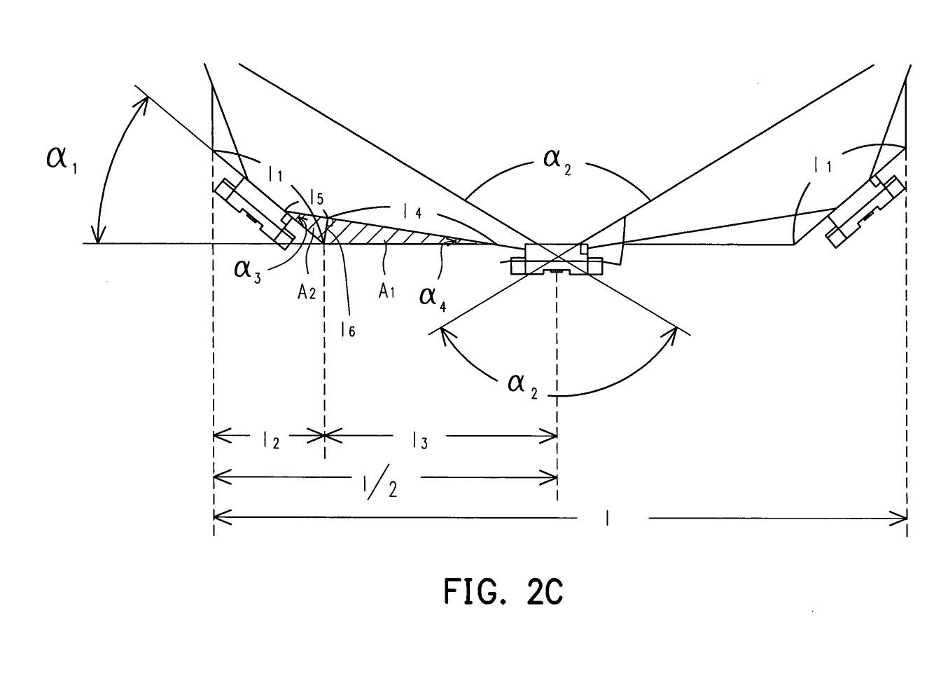

FIG. 2A and FIG. 2B are schematic plan views of the backlight units in accordance with an embodiment of the present invention. Referring to FIG. 2A and FIG. 2B, the backlight unit 200 of the present invention includes a light guide plate (LGP) 210 having an incident surface 212 and a plurality of discrete light sources such as light emitting diodes (LEDs) 220 disposed adjacent to the incident surface 212. (While the illustrated embodiment shows light sources provided at incident surfaces along one edge of the LGP, other edge or edges of the LGP may also be provided with light sources without departing from the scope and spirit of the present invention.) In the present invention, each LED 220 has an light-emitting axis 222. It should be noted that the light-emitting axes 222 of LEDs 220 are not parallel. Taking a surface mounted type (SMT) LED as an example, the LED 220 has a light-emitting surface located at a plane, whose normal vector is parallel to the light-emitting axis 222. In other words, the light-emitting axis 222 of each LED 220 is perpendicular to the light-emitting surface thereof. However, other types of LED, such as LED lamp with multiple pins, lead frame type LED packages or substrate type LED packages etc., may also be used in the present invention. In other type of LEDs, the definition of the light-emitting axis 222 may be different. Generally, the light-emitting axis 222 of the LED 220 may be defined by intensity distribution of luminescence, i.e. the light-emitting axis 222 of the LED 220 may extend along the direction, where the angular intensity distribution of luminescence is the strongest. This may be the axis of symmetry of divergent light intensity distribution. This may or may not be along the direction perpendicular to the supporting substrate of the LED 220.

In the present invention, the LEDs 220 may be mounted on a flexible circuit substrate, rigid circuit substrate or electrically connected with other carriers via conductive wires. In other words, the LEDs may assembled with the carrier in any possible manner.

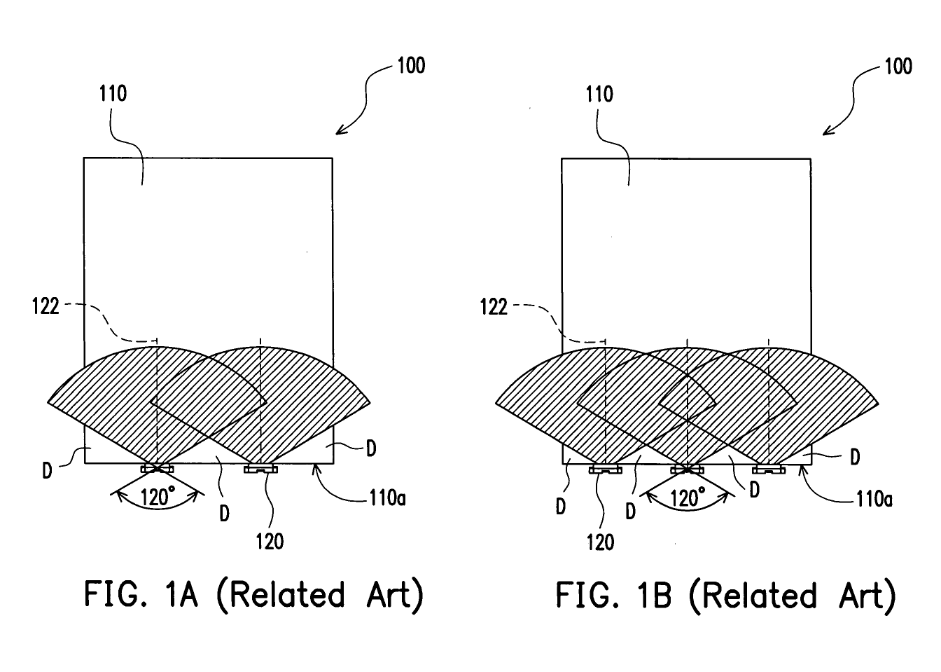

As shown in FIG. 2A and FIG. 2B, the incident surface 212 of the LGP 210 may includes a pair of corner incident surfaces 212a and a central incident surface 212b located or connected between the corner incident surfaces 212a. In FIG. 2A, two LEDs 220 are used in the backlight unit 200. Each of the LEDs 220 are disposed merely adjacent to (or on or against) the corner incident surfaces 212a, respectively. In the configuration shown in FIG. 2A, the dark areas (i.e., areas having an intensity less than 30% compared to areas along the light emitting axis 222 for the same distance from the LED) present in the conventional backlight unit 100 (shown in FIG. 1A and FIG. 1B) are effectively reduced. In other words, the edge portion of the LGP 210 near the incident surface 212b and located between LEDs 220 are better covered by the divergent light of the LEDs.

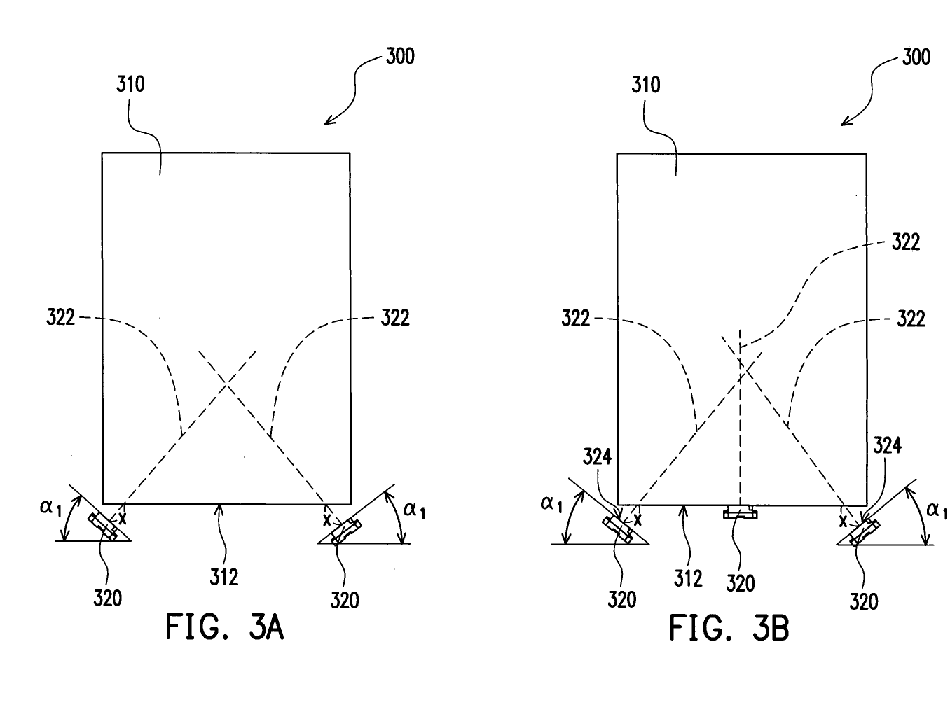

In FIG. 2B, three LEDs 220 are used in the backlight unit 200. Two LEDs are disposed adjacent to (or on or against) both of the corner incident surfaces 212a, and one LED is disposed adjacent to (or on or against) the central incident surface 212b. Two or more light-emitting axis 222 of the LEDs 220 disposed adjacent to the corner incident surfaces 212a and the central incident surface 212b may converge (e.g., intercept at one point) within the LGP 210. However, the crossed point of the light-emitting axes 222 may be located at any other position within the LGP 210. Furthermore, the light-emitting axis 222 of the LED 220 disposed adjacent to the corner incident surfaces 212a and the central incident surface 212b do not have to cross at one point (as shown in FIG. 3B) for other design purposes.

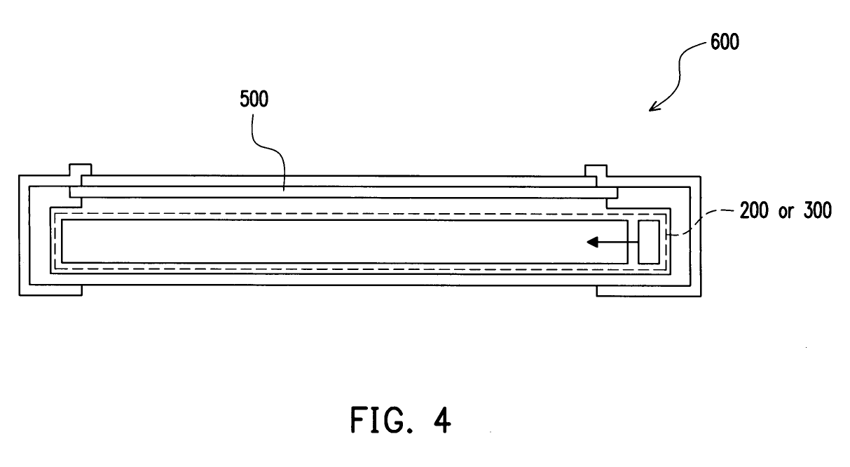

It is noted that with respect to at least FIG. 2A, each corner incident surfaces 212a and extensions of its adjacent edges of the LGP 210, define a triangular space (from a top planar view) in which the structure of the LED 220 (including its associated support structure such as a mounting carrier) substantially resides, such that the structure of the LED 220 does not extend beyond the rectangular planar footprint of the LGP 220. When the LGP 210 and the LED 220 are assembled in a frame (see FIG. 4) to form the liquid crystal display module 600, the frame can be maintained closer to the LGP, therefore resulting in an overall compact structure for the liquid crystal display panel. This is advantages for many applications in which it is desirable to have a display area in a device without very narrow surrounding structures to reduce the overall size of the device, and/or to free up space around the display area for other components. For example, for a notebook computer, it is desirable to maximize the size display panel possible, in a computer housing with a minimum overall size, while providing sufficient space to accommodate components such as wireless antennas, etc., around the liquid crystal display module. Another example is a cellular phone and/or digital camera, wherein given the small overall size of the device housing, it would be desirable to maximize the liquid crystal display screen size and the space adjacent the liquid crystal display module for other electronic and structural components. When the LED 220 is positioned in the triangular space as shown in FIG. 2A, in accordance with the present invention, the inevitable low intensity area or “dark area” (crosshatched region shown more clearly in FIG. 2C) in the LGP 210 in the region outside the divergence angle of the LED 220 can be reduced.

For the embodiment shown in FIG. 2B, a similar effect may be achieved, although in this case, the LED 220 at the corners may also extend a little outside of the triangle region defined by the corner incident surface 212a, since there is already an additional LED at the mid-section of the side surface of the LGP 210. Nonetheless, if desired, the LED 220 may substantially reside within the triangle corner space, to free up space adjacent the LGP for other structures in the liquid crystal display module. As described above, the LEDs 220 disposed adjacent to the LGP 210 may be arranged in other possible manner. In other words, the LEDs 220 disposed adjacent to (or on or against) both of the corner incident surfaces 212a may not be parallel and with different angles, and the LED 220 disposed adjacent to (or on) the central incident surface 212b may also be at an angle. Furthermore, the number and the position of the LEDs used in the backlight unit 200 is not limited.

Referring to FIG. 2A and FIG. 2B, it should be noted that each corner incident surface 212a and the central incident surface 212b may have an acute included angle about α₁ degree, wherein 0<α₁<30. Preferably, the light-emitting axis of the LED 220 disposed adjacent to the corner incident surface 212a is perpendicular to the corner incident surface 212 correspondingly. Moreover, the LED 220 may have a divergence angle of about α₂ degree, and 110<α₂<120. Divergence angle of a light source in this disclosure refers to the angle of spread of light from the light source, within which the intensity at a point at any angle and at a distance from the light source is at least 70% compared to the intensity at the same distance along the light emitting axis (e.g., light emitting axis 222 of the LED 220). That is, at angles beyond the divergence angle α₂, the intensity at a point at a distance from the light source would be 30% or less compared to the intensity at the same distance along an axis of output symmetry of the light source (e.g., the light emitting axis of the LED 220). The determination of the acute included angle α₁ is influenced by many factors, such as the number of the LEDs, the pitch between the adjacent LEDs, the divergence angle α₂ of each LED, etc. Therefore, those skilled artisans may select appropriate acute included angle α₁ according to the design rule set forth herein.

FIG. 2C is a schematic plan view showing the detail parameters (included angle and length etc.) of the backlight units in FIG. 2B. Referring to FIG. 2C, the acute included angle α₁ may be chosen in accordance with certain parameters, such as the width l of the LGP 210, the divergence angle α₂, included angle α_{3, α}₄ and length l₁, l₂, l₃, l₄, l₅, l₆ etc. Given a particular selected geometry of the LGP 210, the width l of the LGP 210, included angle α₃, α₄ and length l₁, l₂, l₃, l₄, l₅, l₆ can be matched to the divergence angle α₂ to reduce dark areas.

Referring to FIG. 2C, since the area A of the crosshatched region (dark area) is a function of α₁ and α₂, we assume that A=∫(α₁, α₂). To facilitate the design of the overall structure of the LGP and LEDs, the derivation may be modeled and explained by the following equations.

$$\begin{matrix}2 {α}_{3} + {α}_{2} = π -> {α}_{3} = ( π - {α}_{2} ) / 2 & ( a ) \\ {α}_{1} = {α}_{3} + {α}_{4} = ( π - {α}_{2} ) / 2 + {α}_{4} -> {α}_{4} = {α}_{1} - ( π - {α}_{2} ) / 2 & ( b ) \\ cos {α}_{1} = {l}_{2} / {l}_{1} \to {l}_{2} = {l}_{1} cos {α}_{1} & \\ {l}_{3} = l / 2 - {l}_{2} = l / 2 - {l}_{1} cos {α}_{1} & ( c ) \\ cos {α}_{4} = {l}_{4} / {l}_{3} \to & \\ {l}_{4} = {l}_{3} cos {α}_{4} = ( l / 2 - {l}_{1} cos {α}_{1} ) cos [ {α}_{1} - ( π - {α}_{2} ) / 2 ] & \\ sin {α}_{4} = {l}_{6} / {l}_{3} \to & \\ {l}_{6} = {l}_{3} sin {α}_{4} = ( l / 2 - {l}_{1} cos {α}_{1} ) sin [ {α}_{1} - ( π - {α}_{2} ) / 2 ] & \\ tan {α}_{3} = {l}_{6} / {l}_{5} \to {l}_{5} = {l}_{6} / tan {α}_{3} & \\ f ( {α}_{1} , {α}_{2} ) = A & ( d ) \\ = A 1 + A 2 & \\ = ( {l}_{4} * {l}_{6} ) / 2 + ( {l}_{5} * {l}_{6} ) / 2 & \\ = 1 / 2 * {( l / 2 - {l}_{1} cos {α}_{1} )}^{2} * cos [ {α}_{1} - ( π - {α}_{2} ) / 2 ] * & \\ sin [ {α}_{1} - ( π - {α}_{2} ) / 2 ] + {l}_{6}^{2} / 2 * tan {α}_{3} & \\ = 1 / 2 * {( l / 2 - {l}_{1} cos {α}_{1} )}^{2} \{ cos [ {α}_{1} - ( π - {α}_{2} ) / 2 ] * & \\ sin [ {α}_{1} - ( π - {α}_{2} ) / 2 ] + {sin}^{2} [ {α}_{1} - ( π - {α}_{2} ) / 2 ] / & \\ tan [ ( π - {α}_{2} ) / 2 ] \} & \end{matrix}$$

As demonstrated above, the area A=∫(α₁, α₂) can be reduced by selecting the appropriate acute included angle α₁ and divergence angle α₂ so as to reduce dark areas. Given the disclosure herein, one skill in the art can easily determine the appropriate acute included angle α₁ and divergence angle α₂, by mathematical modeling, computer simulations, or prototyping. In accordance with the present invention, the light intensity distribution near the incident surface 212b of the LGP 210 can be improved over the prior art.

For example, for an LGP that has an incident surface of about 14 mm long, and two LEDs positioned with respect to the incident surface, the relative light intensity distribution of a prior art structure such as the structure shown in FIG. 1A is compared to that of an inventive structure such as the structure shown in FIG. 2A, at various distances from the incident surface or edge of the LGP. For the prior art structure, two LEDs are positioned against the incident surface, one at the 5 mm location and another at the 9 mm location along the incident surface along one edge of the LGP. For the inventive structure, two LEDs 220 (which for comparison, are similar to LEDs 120 in divergence angle and light intensity property) are positioned one at each corner of the edge of the LGP, with the LEDs against the corrier incident surfaces.

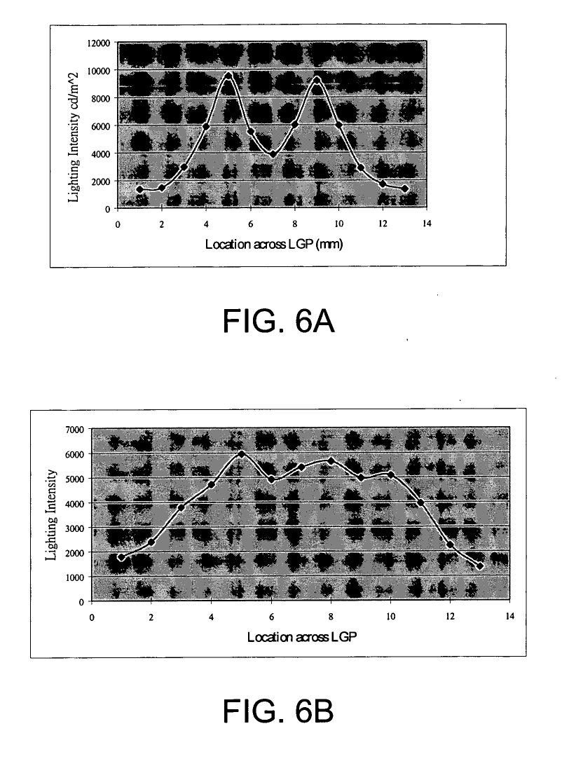

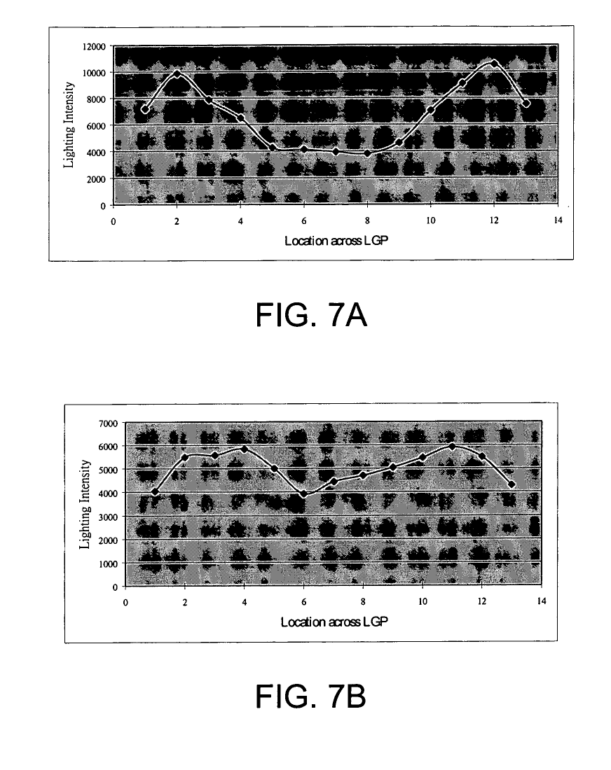

FIGS. 6A and 6B are graphical representation of the relative light intensity distribution across the LGP for the prior art structure at two distances (3 mm and 6 mm) from the incident surface along the edge of the LGP. FIGS. 7A and 7B are graphical representation of the relative light intensity distribution across the LGP for the inventive structure at the same distances from the edge of the LGP. As shown in FIG. 6A, at 3 mm from the incident surface, the light intensity distribution for the prior art structure varies significantly across the LGP, with overall maximum intensity about 5 times the minimum intensity. In comparison, as shown in FIG. 7A, the light intensity distribution for the inventive structure varies less significantly across the LGP, with an overall maximum intensity about 2.5 times the minimum intensity. As shown in FIG. 6B, at 6 mm from the incident surface, while the light intensity distribution for the prior art structure varies less across the LGP as compared to FIG. 6A, the overall maximum intensity is still about 3 times the minimum intensity. In comparison, as shown in FIG. 7B, the light intensity distribution for the inventive structure varies significantly more uniformly across the LGP, as compared to FIG. 7A, with an overall maximum intensity about 1.5 times the minimum intensity. As one can appreciate, the intensity distribution of the inventive structure is relatively more uniform than the intensity distribution of the prior art structure. In the examples shown, the variation in the intensity distribution can be improved by about 50%.

FIG. 3A and FIG. 3B are schematic plan views of the backlight units in accordance with another embodiment of the present invention. Referring to FIG. 3A and FIG. 3B, the backlight unit 300 of the present invention includes a light guide plate (LGP) 310 having a incident surface 312 and a plurality of light emitting diodes (LEDs) 320 disposed adjacent to the incident surface 312. In the present invention, each LED 320 has an light-emitting axis 322. It should be noted that the light-emitting axes 322 of LEDs 320 are not parallel. Comparing with the foregoing embodiment, the shape of the LGP 310 is quite different from that of the LGP 210. In accordance with one embodiment of the present invention, referring to FIG. 3A, two LEDs 320 are used in the backlight unit 300. Both of the LEDs 320 are assembled with the LGP 310 and located at a predetermined distance X from the LGP 310. Furthermore, the tilt angle of each LEDs 320 is about al, wherein 0<α₁<30. In FIG. 3B, three LEDs 320 are used in the backlight unit 300. Two of the LEDs 320 are assembled with the LGP 310 and located at a predetermined distance Xfrom the LGP 310. Furthermore, the tilt angle of each LEDs 320 is about al, wherein 0<α₁<30. Moreover, the other one LED 320 is attached on the incident surface 312 of the LGP 310. More specifically, the tilt angle α₁ is generally defined as an acute included angle between the incident surface 312 and a light-emitting surface 324 of the LEDs 320.

FIG. 4 is schematic cross-sectional view showing a liquid crystal display module comprising the backlight unit 200 or 300 in accordance with another embodiment of the present invention. Referring to FIG. 4, the backlight unit 200 or 300 described above may is assembled with a liquid crystal display panel 500 to form a liquid crystal display module 600. In other words, the liquid crystal display module 600 includes the backlight unit 200 or 300 described above and a liquid crystal display panel 500 disposed over the backlight unit 200 or 300. Specifically, the liquid crystal panel 500 of the liquid crystal display module 600 may be a transflective liquid crystal panel or a transmissive liquid crystal panel.

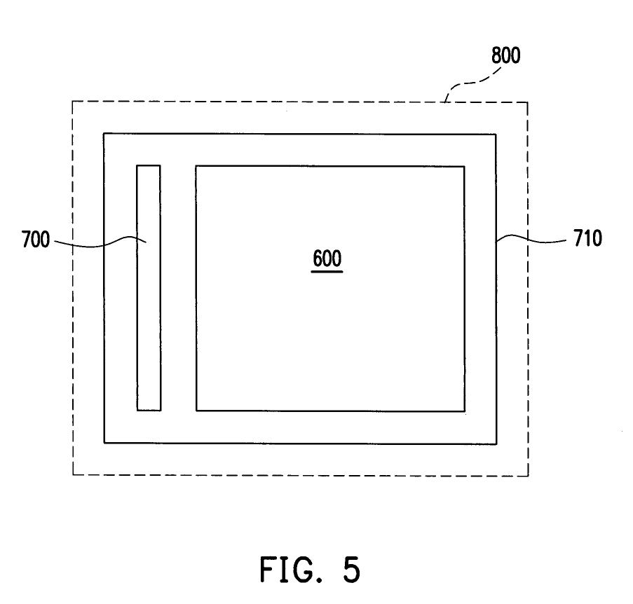

FIG. 5 is schematic cross-sectional view showing an electronic device comprising the liquid crystal display module shown in FIG. 4 in accordance with another embodiment of the present invention. Referring to FIG. 5, the liquid crystal display module 600 shown in FIG. 4 is electrically connected with a control circuitry 700 to form an electronic device 800. In other words, the electronic device 800 includes the liquid crystal display module 600 shown in FIG. 4 and a control circuitry 700 electrically connected to the liquid crystal display module 600. In addition, the liquid crystal display module 600 and the control circuitry 700 may be in installed in a housing 710. The electronic device 800 may be an LCD TV, an LCD monitor, a multi-media player or other devices with screens.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A backlight unit, comprising:
a light guide plate (LGP) having a first edge, a second edge, and a corner incident surface extending from the first edge to the second edge, in which the corner incident surface and extensions of the first edge and second edge define a space; and
at least one light source having a diverging light output at a divergence angle incident at the corner incident surface, wherein the light source is positioned with respect to the corner incident surface such that the light source substantially resides within the space and the diverging light output covers an edge portion of the LGP.

2. The backlight unit as in claim 1, wherein the light source is positioned with respect to the corner incident surface such that an edge of the diverging light output is at least parallel to the incident surface or intercepting the incident surface.

3. The backlight unit as in claim 1, wherein the light source is positioned with respect to the corner incident surface such that an edge of the diverging light output is at least at an angle intersecting the first edge, defining a dark region in the LGP that is outside the divergence angle.

4. The backlight unit as in claim 1, wherein the divergence angle is defined as the angle of spread of light from the light source, within which intensity at a point at any angle and at a distance from the light source is at least 70% compared to the intensity at the same distance along an axis of output symmetry of the light source.

5. The backlight unit as in claim 1, wherein the light source comprises a light emitting diode (LED).

6. The backlight unit according to claim 1, wherein the LGP comprises a pair of corner incident surfaces along the first edge.

7. The backlight unit according to claim 6, wherein the LGP further comprises an incident surface along the first edge, to which another light source is incident.

8. The backlight unit according to claim 3, wherein the light source has a light-emitting axis perpendicular to the corner incident surface.

9. A backlight unit according to claim 8, wherein the corner incident surface and the first edge has an acute included angle about α₁ degree, and 0<α₁<30.

10. The backlight unit according to claim 9, wherein the light source has a divergence angle of about α₂ degree, and 110<α₂<120.

11. The backlight unit according to claim 10, wherein the dark region has an area about ½*(l/2−l₁ cos α₁)²{cos[α₁−(π−α₂)/2]*sin[α₁−(π−α₂)/2]+sin²α₁−(π−α₂)/2tan[(π−α₂)/2]}.

12. A liquid crystal display module, comprising:
a backlight unit as in claim 1; and
a liquid crystal display panel positioned relative to the backlight unit.

13. An electronic device, comprising:
a liquid crystal display panel as in claim 12; and
a control circuitry operatively coupled to the liquid crystal display module to control display of an image in accordance with image data.
